(19) United States
(12) Patent Application Publication
(10) Pub. No.: US 2017/0168706 A1
(43) Pub. Date: Jun. 15, 2017

(54) METHOD AND ELECTRONIC DEVICE FOR SWITCHING VIDEOS

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Bin SHI, Beijing (CN)

(21) Appl. No.: 15/242,421

(22) Filed: Aug. 19, 2016

Related U.S. Application Data
(63) Continuation of application No. PCT/CN2016/088927, filed on Jul. 6, 2016.

(30) Foreign Application Priority Data
Dec. 14, 2015 (CN) 201510922869.6

(51) Int. Cl. G06F 3/0488; G06F 3/0485; G06F 3/0482

(52) U.S. Cl. CPC G06F 3/04883; G06F 3/0482; G06F 3/0485

(57) ABSTRACT

The present disclosure provides a method and electronic device for switching videos in a sliding manner. The method includes: obtaining a first touch event of a user on a screen, in an interface of a video player of a terminal device; generating a poster layer over the interface of the video player, if the first touch event is a sliding operation in a predetermined direction; displaying a poster of an optional video in a translational sliding manner on the poster layer, along with a displacement of the sliding operation; and hiding the poster layer and playing the optional video on the interface of the video player, if it is determined that more than half of a poster of an optional video, a translational slide of which is stopped, is exposed, after it is obtained that the sliding operation has finished.

### CROSS-REFERENCE TO RELATED APPLICATIONS

The present disclosure is a continuation of international application No. PCT/CN2016/088927 filed on Jul. 6, 2016, and claims a priority of Chinese Patent Application No. 201510922869.6, titled “METHOD AND SYSTEM FOR SWITCHING VIDEOS” filed with the State Intellectual Property Office of China on Dec. 14, 2015, both of which are incorporated herein by reference in its entireties.

### TECHNICAL FIELD

The present disclosure relates to the field of multimedia playing, and in particular, to a method and electronic device for switching videos.

### BACKGROUND

For playing videos, the users not only look forward to live broadcast videos more timely, but also have a higher demands on experience in operating videos. However, in the existing terminals, if users want to switch to a next video, the users have to close the video being watched currently, and then open the next video, or select and click the next video in a playlist, or play the next video through a shortcut key. Thus, not only the number of operations is increased when the users switch videos, but also it is difficult to switch videos for some users of operation inconvenience.

### SUMMARY

In view of above, an object of the present disclosure is to provide a method and electronic device for switching videos, so that a user may switch contents of videos quickly and easily.

In a first aspect, based on the above object, a method for switching videos is provided according to the present disclosure, which is applied to a terminal device with a touch screen. The method includes at an electronic device:

obtaining a first touch event of a user on a screen, in an interface of a video player;

generating a poster layer over the interface of the video player, if the first touch event is a sliding operation in a predetermined direction;

displaying a poster of an optional video in a translational sliding manner on the poster layer, along with a displacement of the sliding operation; and

hiding the poster layer and playing the optional video on the interface of the video player, if it is determined that more than half of a poster of an optional video, a translational slide of which is stopped, is exposed, after obtaining that the sliding operation has finished.

In a second aspect, a non-volatile computer-readable storage medium is provided according to embodiments of the present disclosure, which is stored with computer executable instructions, which are used to perform any one of the above methods for switching videos of the present disclosure.

In a third aspect, an electronic device is provided according to embodiments of the present disclosure, which includes at least one processor and a memory communicably connected with the at least one processor and storing instructions executable by the at least one processor, wherein the instructions are set to perform any one of the above methods for switching videos of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of an embodiment of a method for switching videos according to the present disclosure;

FIG. 2 is a flow chart of another embodiment of a method for switching videos according to the present disclosure;

FIG. 3 is a schematic structural diagram of an embodiment of a system for switching videos according to the present disclosure; and

FIG. 4 is a hardware structure diagram of a device for performing a method for switching videos according to embodiments of the present disclosure.

### DETAILED DESCRIPTION

In order to make the objects, technical solutions and advantages of the present disclosure more clear and apparent, the present disclosure is described in details in conjunction with the embodiments and the drawings.

It should be noted that, all description of “first” and “second” used in the embodiments of the present disclosure are used to distinguish two different entities or parameters of the same name, and the “first” and “second” are merely convenient for expression and should not be construed as limiting the embodiments of the present disclosure, which are not illustrated any more in the following embodiments.

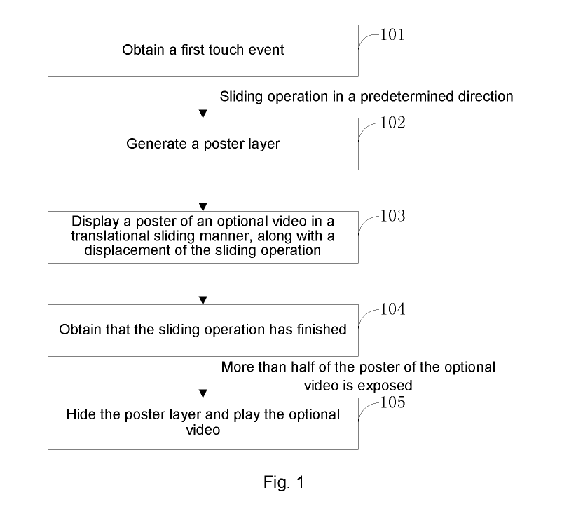

Referring to FIG. 1, it shows an embodiment of a method for switching videos according to the present disclosure, which is applied to a terminal device with a touch screen. The method includes the following steps.

In step S101, a first touch event of a user on a screen is obtained in an interface of a video player of the terminal device.

The method for switching videos generally is used to perform a sliding operation on a terminal device with a touch screen to achieve a switching instruction, when a user wants to switch to another video playing in an interface of a video player of the terminal device. The first touch event refers to a touch operation instruction of the user on the touch screen.

In step S102, a poster layer is generated over the interface of the video player.

In this step, a location where the interface of the video player is displayed is kept to be fixed, and a transparent poster layer is generated over the interface of the video player, if the first touch event is a sliding operation in a predetermined direction. The poster layer may display posters of other optional videos in suspension.

The posters include publicized images, which are associated with video files and include massive video information. The posters may be publicized posters of the videos, or may also be screen captures which are extracted from the videos and include massive video information. If the first touch event is another operation, another corresponding instruction is executed. For example, if the first touch event is an operation of clicking screen, a playing state of a video is changed, that is, the playing state is changed from being played to being paused, or from being paused to being played.

The sliding operation in the predetermined direction may be set to be a left to right sliding operation or a right to left sliding operation, or may also be set to be an up to down sliding operation or a down to up sliding operation. Furthermore, the sliding operation may be preset to be performed in a specific region, for example, in the video player, on the touch screen. For example, if it is determined that the sliding operation in the predetermined direction is performed in the specific region, the following steps are performed.

In step S103, a poster of an optional video is displayed on the poster layer in a translational sliding manner, along with a displacement of the sliding operation.

The displayed poster is correspondingly translated with the movement of the sliding operation, that is, the poster may be moved out from an edge of the video player or an edge of the touch screen through a slide. In this case, the user not only can control the displaying of the poster, but also can control a location where a touch point is released through a displacement of the sliding operation, thereby switching videos.

In step S104, an end of the sliding operation is obtained.

A location where the sliding operation has finished is determined, that is, a location where the sliding touch point is released is determined. Therefore, a user may switch videos or not, with the displacement of the sliding operation, and a user may view the poster of the video or consider whether the video is switched in a period of the touch operation by staying the touch point to be not released. If the user wants to view a poster of a next video, the user may continuously perform the sliding operation; if the user does not want to view the video corresponding to the poster, the user may also slide the poster back.

In step S105, the poster layer is hided and the optional video is played in the interface of the video player, if it is determined that more than half of a poster of an optional video, a translational slide of which is stopped, is exposed.

In an optional embodiment, after the sliding operation has finished, whether more than half of a poster is exposed is determined by calculating a displayed area of the poster. Which video file to be played is determined by comparing the displayed area of the poster. If more than half of a poster of an optional video is exposed, it represents that a user wants to switch to the optional video. In this case, the poster is hided and the optional video is played directly, thereby achieving the effect of quickly switching videos. The area of the poster displayed in the interface of the video player is calculated to determine which video the user wants to play, that is, the area of the poste corresponding to the optional video to be played is made larger by the user through the slide operation. In this case, the user has more choices and flexibility in the sliding switching operation, and the stability of the video switching method is improved.

In addition, whether more than half of a poster is exposed is determined by determining whether the exposed part of the poster exceeds a predetermined middle point. For example, a predetermined direction is set to be a left-right direction, the poster is set to be slid out in the left-right direction, and a middle point (or midline) in the left-right direction may be preset in the video player. When a sliding operation of a user toward left or right is received, the poster is slid out from the left or the right. After the translational sliding of the poster is stopped, it is determined whether the currently exposed part of the poster exceeds the predetermined middle point (or midline), that is, it is determined whether the predetermined middle point (or midline) of the video player is covered. If the currently exposed part of the poster exceeds the predetermined middle point (or midline), it is determined that more than half of the poster is exposed.

As can be seen from the above embodiment, in the method of switching videos, the poster of the video is obtained and displayed through the sliding operation in a predetermined direction, and the poster is moved with the sliding of the touch point, so that the user not only can preview video information in advance, but also can select a video to be switched to by sliding the poster corresponding to the video. In this way, a user may quickly switch videos through only a single sliding operation, thereby improving the speed of switching videos by the user and improving user's experience.

In some optional embodiments, the method further includes after the obtaining the first touch event of the user on the screen: determining a speed of the sliding operation based on a predetermined threshold, and if the sliding operation is a fast sliding operation with a speed greater than the predetermined threshold, continuing displaying the poster of the optional video in a decelerated sliding manner with an acceleration value until a translational slide is stopped, after obtaining that the sliding operation has finished. In this way, the user may issue different operation instructions with a single sliding operation by presetting the threshold of the sliding speed. If the sliding speed is greater than the predetermined threshold, it represents that the user wants to quickly switch multiple video files. In this case, the posters of the optional videos are displayed in a decelerated sliding manner with an acceleration value until the translational sliding operation is stopped, so that the user may switch multiple video files at a time, thereby further improving the efficiency and speed of switching videos.

In some optional embodiments, the determining that more than half of a poster of an optional video, a translational slide of which is stopped, is exposed includes: determining whether an area of the poster displayed in the interface of the video player is more than half of a whole area of the poster, and if the area of the poster displayed in the interface of the video player is more than half of the whole area of the poster, determining that more than half of the poster is exposed.

In some optional embodiments, the obtaining that the sliding operation has finished includes: obtaining whether there is a second touch event by the user in a predetermined time threshold, if there is a second touch event by the user in the predetermined time threshold, and it is further determined that the second touch event is a sliding operation in the predetermined direction, continuing displaying the poster of the optional video in the translational sliding manner with a corresponding speed, until a translational slide is stopped; if there is not a second touch event by the user in the predetermined time threshold, determining that the sliding operation has finished.

After the first sliding switching operation, the user may not achieve switching videos, and the video switching operation is required to be performed once again. It is determined whether the user performs a sliding switching operation once again, that is, whether there is a second touch event, and then it is determined whether the sliding operation has finished. If the user does not slide the video in a predetermined time threshold, it represents that the sliding operation has finished, that is, the switching of the video is completed. If the user continues to slide the video in the predetermined time threshold, it is determined whether the user slides the video in a predetermined direction. If the user slides the video in the predetermined direction, the poster of the optional video is displayed in a translational sliding manner with a corresponding speed, according to the user's sliding speed, until the translational sliding operation is stopped. The following sliding operations may be continued until the user finds the poster corresponding to the video to be played. In this way, the efficiency of switching videos by a user is significantly improved.

In some optional embodiments, the poster includes posters of a plurality of optional videos, and the displaying the poster of the optional video in the translational sliding manner includes: displaying the posters of the plurality of optional videos in the translation sliding manner so that the posters of the plurality of optional videos are conterminous in sequence. The posters are ranked in sequence according to the list information of the videos. When the poster layer is displayed in the interface of the video player, the posters are ranked in sequence. With the sliding of the touch point, the posters of the optional videos in the translational sliding manner so that the posters of the optional videos are conterminous in sequence.

In some optional embodiments, the poster layer is hided and it is returned to a state before the first touch event, if it is determined that less than half of the poster of the optional video, a translational slide of which is stopped, is exposed, after obtaining that the sliding operation has finished. When the user performs the sliding switching operation in the first touch event, the sliding distance is too short to expose more than half of a poster of an optional video, which represents that the user does not intend to switch videos. In this case, it is returned to the state before the first touch event. In this way, the user has more choices, and the user may quit switching videos timely and continues to view the original video, thereby significantly improving user's experience.

Alternatively, the user may directly switch videos by the sliding operation without viewing the posters; or the user may directly switch videos by quickly sliding a short distance in a direction.

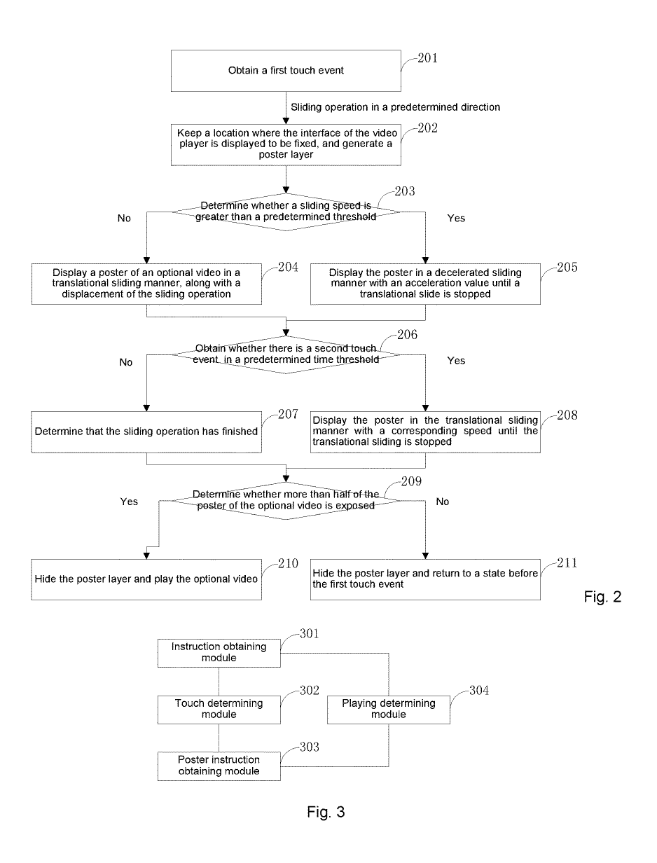

Referring to FIG. 2, it is a flow chart of another embodiment of a method for switching videos according to the present disclosure. The method for switching videos includes the following steps.

In step S201, a first touch event of a user on a screen is obtained in an interface of a video player of a terminal device.

In step S202, a location where the interface of the video player is displayed is kept to be fixed and, a poster layer is generated over the interface of the video player, if the first touch event is a sliding operation in a predetermined direction.

In step S203, it is determined whether a sliding speed of the first touch event is greater than a predetermined threshold, if yes, step S205 is performed, otherwise, step S204 is performed.

In step S204, based on step S203, a poster of an optional video is displayed in a translational sliding manner on the poster layer along with a displacement of the sliding operation, if the sliding speed of the first touch event is not greater than the predetermined threshold.

In step S205, based on step S203, the poster of the optional video is displayed in a decelerated sliding manner with an acceleration value until the translational sliding is stopped, if the sliding speed of the first touch event is greater than the predetermined threshold.

In step S206, it is obtained whether there is a second touch event by the user in a predetermined time threshold (for example, 1/2 seconds), if yes, step S208 is performed, otherwise, step S207 is performed.

In step S207, based on step S206, it is determined that the sliding operation has finished, if there is not a second touch event by the user.

In step S208, based on step S206, if it is determined that there is a second touch event by the user and the second touch event is a sliding operation in the predetermined direction, it is continued to display the poster of the optional video in the translational sliding manner with a corresponding speed until the translational sliding is stopped.

In step S209, it is determined whether the exposed part of the poster of the optional video in the interface of the video player is more than half of the whole area of the poster, if yes, step S210 is performed, otherwise, step S211 is performed.

In step S210, based on step S209, if the exposed part of the poster of the optional video is more than half of the whole area of the poster, the poster layer is hided and the optional video is played.

In step S211, based on step S209, if the exposed part of the poster of the optional video is not more than half of the whole area of the poster, it is returned to a displaying state before the first touch event.

Optionally, in this step, it may be displayed that the poster of the optional video is returned to along the original path and disappears at the edge of the display screen or the video player.

As can be seen from the above embodiment, in the method of switching videos in a sliding manner, different switching speeds are determined according to a predetermined threshold, and a second touch time is determined according to a predetermined displaying time threshold. Therefore, a user may quickly implement various demands of switching videos, significantly improving the efficiency and speed of switching videos.

Referring to FIG. 3, it is a structural diagram of an embodiment of a system for switching videos according to the present disclosure. The system for switching videos is applied to a terminal device with a touch screen, and includes: an instruction obtaining module 301, a touch determining module 302, a poster instruction obtaining module 303 and a playing determining module 304.

The instruction obtaining module 301, obtains a first touch event of a user on the screen in an interface of a video player of the terminal device, and obtains an end of the sliding operation.

The touch determining module 302 determines that the first touch event is the sliding operation in the predetermined direction, and instructs a poster instruction obtaining module to obtain a poster of an optional video after the first touch event of the user on the screen is obtained by the instruction obtaining module 301.

The poster instruction obtaining module 303 obtains the poster of the optional video according to the instructing by the touch determining module 302, generates a poster layer over the interface of the video player, and displays the poster of the optional video in a translational sliding manner, along with a displacement of the sliding operation.

The playing determining module 304 hides the poster layer and playing the optional video on the interface of the video player, if it is determined that more than half of a poster of an optional video, a translational slide of which is stopped, is exposed, after it is obtained by the instruction obtaining module that the sliding operation has finished.

As can be seen from the above embodiment, in the system of for switching videos, the switching operation of the user, i.e., the first touch event, is obtained by the instruction obtaining module 301, if it is determined by the touch determining module 302 that the first touch event is the sliding operation in the predetermined direction, the poster instruction obtaining module 303 obtains the poster of the optional video, then the videos are switched by sliding the poster, and the playing determining module 304 may determine which video the user intends to play. Therefore, not only the user has more choices in the sliding operation, but also the stability of the sliding switch operation is improved.

In some optional embodiments, the touch determining module 302 further determines a speed of the sliding operation based on a predetermined threshold, and if the sliding operation is a fast sliding operation with a speed greater than the predetermined threshold, continues displaying the poster of the optional video in a decelerated sliding manner with an acceleration value until a translational slide is stopped, after it is obtained by the instruction obtaining module 301 that the sliding operation has finished. In this way, the user may quickly switch videos by controlling a sliding speed, that is, multiple videos are switched through a single sliding operation, thereby significantly improving the efficiency of switching videos.

In some optional embodiments, the determining that more than half of a poster of an optional video, a translational slide of which is stopped, is exposed by the playing determining module 304 includes: determining whether an area of the poster displayed in the interface of the video player is more than half of a whole area of the poster, and if the area of the poster displayed in the interface of the video player is more than half of the whole area of the poster, determining that more than half of the poster is exposed.

By determining the area of the poster displayed in the interface of the video player, a sliding instruction of the user becomes clear, which has excellent stability and operability.

In some optional embodiments, the touch determining module 302 further obtains whether there is a second touch event by the user in a predetermined time threshold, and if there is a second touch event by the user in the predetermined time threshold, and it is further determined that the second touch event is the sliding operation in the predetermined direction, continues displaying the poster of the optional video in the translational sliding manner with a corresponding speed, until a translational slide is stopped; and if there is not a second touch event by the user in the predetermined time threshold, determines that the sliding operation has finished.

In the first touch event, that is, the sliding switching operation, the user may not find the video to be switched to. Hence, it is further determined whether the user wants to switch videos once again by setting a time threshold. If the user wants to switch videos once again, the posters of the optional videos are displayed in the translational sliding manner with a corresponding speed according to the user's second touch event and the speed of the second sliding operation, so that the user may view the posters one by one until the poster corresponding to the video to be switched to is found. In this way, the efficiency of switching videos by a user is significantly improved.

In some optional embodiments, the displaying the poster of the optional video in the translational sliding manner by the poster instruction obtaining module 303 includes: displaying posters of a plurality of optional videos in the translational sliding manner so that the posters of the plurality of optional videos are conterminous in sequence.

In the way of displaying the posters of the optional videos in a manner that the posters of the optional videos are conterminous in sequence, the user may quickly review information of the posters, thereby significantly improving the efficiency of switching videos.

In some optional embodiments, the playing determining module 304 further hides the poster layer and returns to a state before the first touch event, if it is determined that less than half of the poster of the optional video, a translational slide of which is stopped, is exposed, after it is obtained by the instruction obtaining module 301 that the sliding operation has finished.

In the case that less than half of the poster of the optional video is exposed, it represents that the user changes his/her mind and does not want to switch videos. In this case, it is returned to the state before the first touch event. The user may cancel the operation of switching videos in time, that is, the user may go back and return to the original state in time, thereby significantly improving user's experience.

Embodiments of the present disclosure may provide a non-volatile computer storage medium stored with computer executable instructions which are used to perform any one of the methods for switching videos in the above method embodiments.

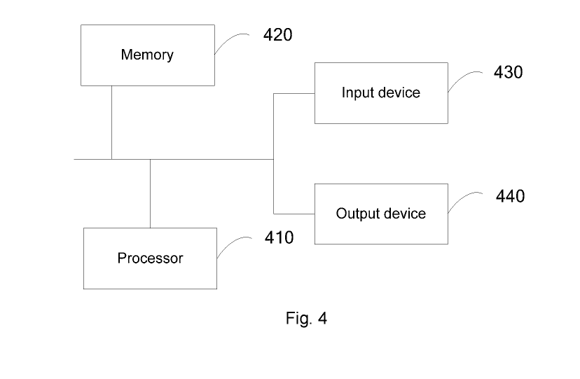

FIG. 4 is a hardware structure diagram of an electronic device for performing a method for switching videos according to an embodiment of the present disclosure. As shown in FIG. 4, the device includes one or more processors 410 and a memory 420, and FIG. 4 illustrates one processor 410 as an example.

The device for performing a method for switching videos may further include an input device 430 and an output device 440.

The processor 410, memory 420, input device 430 and output device 440 may be connected with each other through bus or other forms of connections. FIG. 4 illustrates bus connection as an example.

As a non-volatile computer readable storage medium, the memory 420 may be configured to store non-volatile software program, non-volatile computer executable program and modules, such as program instructions/modules corresponding to the method for switching videos according to the embodiments of the present disclosure (for example, the instruction obtaining module 301, touch determining module 302, poster instruction obtaining module 303 and playing determining module 304, as illustrated in FIG. 3). By executing the non-volatile software program, instructions and modules stored in the memory 420, the processor 410 may perform various functional applications of a server and data processing, that is, the method for switching videos according to the above method embodiments.

The memory 420 may include a program storage area and a data storage area, the program storage area may be stored with an operating system and applications which are needed by at least one functions, and the data storage area may be stored with data which is created according to use of the device for switching videos. Further, the memory 420 may include a high-speed random access memory, and may further include a non-volatile memory, such as at least one of disk memory device, flash memory device or other types of non-volatile solid state memory device. In some embodiments, optionally, the memory 420 may include a memory provided remotely from the processor 410, and such memory may be connected with the device for switching videos through network connections. The examples of the network connections may include but not limited to internet, intranet, LAN (Local Area Network), mobile communication network or combinations thereof.

The input device 430 may receive inputted digital or character information, and generate key signal input related to the user settings and functional control of the device for switching videos. The output device 440 may include a display device such as a display screen.

The above one or more modules may be stored in the memory 420, and when these modules are executed by the one or more processor 410, the method for switching videos according to any one of the above method embodiments may be performed.

The above product may perform the methods provided in the embodiments of the present disclosure, and include functional modules corresponding to these methods and advantageous effects. Further technical details which are not described in detail in the present embodiment may refer to the methods provided according to embodiments of the disclosure.

The electronic device in embodiments of the present disclosure may be embodied in various forms, including but not limited to:

(1) mobile communication device, characterized in having a function of mobile communication and mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smart toys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned embodiments for the device are merely illustrative, wherein the unit illustrated as a separated component may be or may not be physically separated, the component illustrated as a unit may be or may not be a physical unit, in other words, may be either disposed in a same place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to perform the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for switching videos, comprising at an electronic device:
obtaining a first touch event of a user on a screen, in an interface of a video player;
generating a poster layer over the interface of the video player, if the first touch event is a sliding operation in a predetermined direction;
displaying a poster of an optional video in a translational sliding manner on the poster layer, along with a displacement of the sliding operation; and
hiding the poster layer and playing the optional video on the interface of the video player, if it is determined that more than half of a poster of an optional video, a translational slide of which is stopped, is exposed, after obtaining that the sliding operation has finished.

2. The method according to claim 1, wherein after obtaining a first touch event of the user on the screen, further comprising:
determining a speed of the sliding operation based on a predetermined threshold, and if the sliding operation is a fast sliding operation with a speed greater than the predetermined threshold, continuing displaying the poster of the optional video in a decelerated sliding manner with an acceleration value until the translational slide is stopped, after obtaining that the sliding operation has finished.

3. The method according to claim 1, wherein, the determining that more than half of a poster of an optional video, a translational slide of which is stopped, is exposed comprises:
determining whether an area of a poster displayed in the interface of the video player is more than half of a whole area of the poster, and if the area of the poster displayed in the interface of the video player is more than half of the whole area of the poster, determining that more than half of the poster is exposed.

4. The method according to claim 1, wherein, the obtaining that the sliding operation has finished comprises:
obtaining whether there is a second touch event by the user in a predetermined time threshold,
if there is a second touch event by the user in the predetermined time threshold, and it is further determined that the second touch event is a sliding operation in the predetermined direction, continuing displaying the poster of the optional video in the translational sliding manner with a corresponding speed, until a translational slide is stopped; if there is not a second touch event by the user in the predetermined time threshold, determining that the sliding operation has finished.

5. The method according to claim 1, wherein, the poster comprises posters of a plurality of optional videos, and the displaying the poster of the optional video in the translational sliding manner comprises:
displaying the posters of the plurality of optional videos in the translational sliding manner so that the posters of the plurality of optional videos are conterminous in sequence.

6. The method according to claim 1, further comprising:
hiding the poster layer and returning to a state before the first touch event, if it is determined that less than half of the poster of the optional video, a translational slide of which is stopped, is exposed, after obtaining that the sliding operation has finished.

7. A non-volatile computer-readable storage medium, which is stored with computer executable instructions that, when executed by an electronic device, cause the electronic device to:
obtain a first touch event of a user on a screen, in an interface of a video player of a terminal device;
generate a poster layer over the interface of the video player, if the first touch event is a sliding operation in a predetermined direction;
display a poster of an optional video in a translational sliding manner on the poster layer, along with a displacement of the sliding operation; and
hide the poster layer and play the optional video on the interface of the video player, if it is determined that more than half of a poster of an optional video, a translational slide of which is stopped, is exposed, after obtaining that the sliding operation has finished.

8. The non-volatile computer-readable storage medium according to claim 7, wherein, the electronic device is further caused to:
determine a speed of the sliding operation based on a predetermined threshold, and if the sliding operation is a fast sliding operation with a speed greater than the predetermined threshold, continue displaying the poster of the optional video in a decelerated sliding manner with an acceleration value until the translational slide is stopped, after obtaining that the sliding operation has finished.

9. The non-volatile computer-readable storage medium according to claim 7, wherein, the execution of the instructions to determine that more than half of a poster of an optional video, a translational slide of which is stopped, is exposed causes the electronic device to:
determine whether an area of a poster displayed in the interface of the video player is more than half of a whole area of the poster, and if the area of the poster displayed in the interface of the video player is more than half of the whole area of the poster, determine that more than half of the poster is exposed.

10. The non-volatile computer-readable storage medium according to claim 7, wherein, the execution of the instructions to obtain that the sliding operation has finished cause the electronic device to: obtain whether there is a second touch event by the user in a predetermined time threshold,
if there is a second touch event by the user in the predetermined time threshold, and it is further determined that the second touch event is a sliding operation in the predetermined direction, continue displaying the poster of the optional video in the translational sliding manner with a corresponding speed, until a translational slide is stopped; if there is not a second touch event by the user in the predetermined time threshold, determine that the sliding operation has finished.

11. The non-volatile computer-readable storage medium according to claim 7, wherein, the poster comprises posters of a plurality of optional videos, and the execution of the instructions to display the poster of the optional video in the translational sliding manner cause the electronic device to: display the posters of the plurality of optional videos in the translational sliding manner so that the posters of the plurality of optional videos are conterminous in sequence.

12. The non-volatile computer-readable storage medium according to claim 7, wherein, the electronic device is further caused to: hide the poster layer and return to a state before the first touch event, if it is determined that less than half of the poster of the optional video, a translational slide of which is stopped, is exposed, after obtaining that the sliding operation has finished.

13. An electronic device, comprising:
at least one processor; and
a memory, communicably connected with the at least one processor and storing instructions executable by the at least one processor,
wherein execution of the instructions by the at least one processor causes the at least one processor to:
obtain a first touch event of a user on a screen, in an interface of a video player of a terminal device;
generate a poster layer over the interface of the video player, if the first touch event is a sliding operation in a predetermined direction;
display a poster of an optional video in a translational sliding manner on the poster layer, along with a displacement of the sliding operation; and
hide the poster layer and play the optional video on the interface of the video player, if it is determined that more than half of a poster of an optional video, a translational slide of which is stopped, is exposed, after obtaining that the sliding operation has finished.

14. The electronic device according to claim 13, wherein, the at least one processor is further caused to:
determine a speed of the sliding operation based on a predetermined threshold, and if the sliding operation is a fast sliding operation with a speed greater than the predetermined threshold, continue displaying the poster of the optional video in a decelerated sliding manner with an acceleration value until the translational slide is stopped, after obtaining that the sliding operation has finished.

15. The electronic device according to claim 13, wherein, the execution of the instructions to determine that more than half of a poster of an optional video, a translational slide of which is stopped, is exposed causes the at least one processor to:
determine whether an area of a poster displayed in the interface of the video player is more than half of a whole area of the poster, and if the area of the poster displayed in the interface of the video player is more than half of the whole area of the poster, determining that more than half of the poster is exposed.

16. The electronic device according to claim 13, wherein, the execution of the instructions to obtain that the sliding operation has finished causes the at least one processor to: obtain whether there is a second touch event by the user in a predetermined time threshold,
if there is a second touch event by the user in the predetermined time threshold, and it is further determined that the second touch event is a sliding operation in the predetermined direction, continue displaying the poster of the optional video in the translational sliding manner with a corresponding speed, until a translational slide is stopped; if there is not a second touch event by the user in the predetermined time threshold, determine that the sliding operation has finished.

17. The electronic device according to claim 13, wherein, the poster comprises posters of a plurality of optional videos, and the execution of the instructions to display the poster of the optional video in the translational sliding manner causes the at least one processor to: display the posters of the plurality of optional videos in the translational sliding manner so that the posters of the plurality of optional videos are conterminous in sequence.

18. The electronic device according to claim 13, wherein, the at least one processor is further caused to: hide the poster layer and return to a state before the first touch event, if it is determined that less than half of the poster of the optional video, a translational slide of which is stopped, is exposed, after obtaining that the sliding operation has finished.
